(19) United States
(12) Patent Application Publication
(10) Pub. No.: US 2024/0114331 A1
(43) Pub. Date: Apr. 4, 2024

(54) MOBILITY MANAGEMENT APPARATUS, MOBILITY MANAGEMENT SYSTEM, AND MOBILITY MANAGEMENT METHOD

(71) Applicant: NEC Corporation, Tokyo (JP)

(72) Inventor: Chihiro Miyakoshi, Tokyo (JP)

(73) Assignee: NEC Corporation, Tokyo (JP)

(21) Appl. No.: 18/219,992

(22) Filed: Jul. 10, 2023

(30) Foreign Application Priority Data
Sep. 29, 2022 (JP) 2022-156790

(51) Int. Cl. H04W 8/02; H04W 64/00; H04W 76/10

(52) U.S. Cl. CPC H04W 8/02; H04W 64/00; H04W 76/10

(57) ABSTRACT

A mobility management apparatus (10) is a mobility management apparatus that establishes a communication connection, via a network connected on the basis of cooperation between communication providers in a roaming country and a home country which has a plurality of time zones, with a connection destination that is selected from a plurality of session management apparatuses in the home country, the mobility management apparatus including at least one processor (C1), the at least one processor (C1) carrying out a selection process (S11) for selecting the connection destination, on the basis of time zone information indicating a time zone to which each of the plurality of session management apparatuses belongs.

This application is based upon and claims the benefit of priority from Japanese patent application No. 2022-156790, filed on Sep. 29, 2022, the disclosure of which is incorporated herein in its entirety by reference.

### TECHNICAL FIELD

The present invention relates to a technology for selecting a connection destination in international roaming connection via a network that is connected on the basis of cross-border cooperation between communication providers.

### BACKGROUND ART

Known are a communication technology for performing international roaming connection between a home country and a roaming country and related technologies. In some cases, a home country and a roaming country are in different time zones. Accordingly, a user in a roaming country may perform international roaming though the home country is in the midnight. In light of this, Patent Literature 1 discloses a technology according to which in a case where a time period of a day in a home country is in the midnight on the basis of time in the home country (user's country) and a time difference between the home country and a roaming country where a roaming destination exists, a warning to that effect is displayed or connection to a service server in the home country is restricted.

### CITATION LIST

### Patent Literature

### Patent Literature 1

Japanese Patent Application Publication, Tokukai, No. 2008-301435

### SUMMARY OF INVENTION

### Technical Problem

The technology disclosed in Patent Literature 1 is useful. On the other hand, there are other technical problems to be solved in international roaming. For example, it is useful to shorten a time to establish a communication connection, by international roaming connection, with a connection destination via a network connected on the basis of cross-border cooperation between communication providers.

An example object of an example aspect of the invention is to provide a mobility management apparatus capable of shortening a time to establish a communication connection with a connection destination that performs international roaming connection via a network that is connected on the basis of cross-border cooperation between communication providers, and technologies related to the mobility management apparatus.

### Solution to Problem

A mobility management apparatus according to an example aspect of the invention is a mobility management apparatus that establishes a communication connection, via a network connected on the basis of cooperation between communication providers in a roaming country and a home country which has a plurality of time zones, with a connection destination that is selected from a plurality of session management apparatuses in the home country, the mobility management apparatus including at least one processor, the at least one processor carrying out a selection process for selecting the connection destination, on the basis of time zone information indicating a time zone to which each of the plurality of session management apparatuses belongs.

A mobility management system according to an example aspect of the invention is a mobility management system including a mobility management apparatus, a network information management apparatus and a plurality of session management apparatuses, the mobility management apparatus being an apparatus that establishes a communication connection, via a network connected on the basis of cooperation between communication providers in a roaming country and a home country which has a plurality of time zones, with a connection destination that is selected from the plurality of session management apparatuses in the home country, the mobility management apparatus including at least one processor, the at least one processor carrying out: a communication process for receiving, from the network information management apparatus, time zone information indicating a time zone to which each of the plurality of session management apparatuses belongs, and establishing a communication connection with the connection destination; and a selection process for selecting the connection destination, on the basis of the time zone information, the network information management apparatus carrying out a communication process for sending the time zone information to the mobility management apparatus, the session management apparatus carrying out a communication process for establishing the communication connection with the mobility management apparatus.

A mobility management method according to an example aspect of the invention is a mobility management method for establishing a communication connection, via a network connected on the basis of cooperation between communication providers in a roaming country and a home country which has a plurality of time zones, with a connection destination that is selected from a plurality of session management apparatuses in the home country, the method including selecting, by at least one processor, the connection destination, on the basis of time zone information indicating a time zone to which each of the plurality of session management apparatuses belongs.

### Advantageous Effects of Invention

An example aspect of the invention makes it possible to provide a mobility management apparatus capable of shortening a time to establish a communication connection with a connection destination via a network that is connected on the basis of cross-border cooperation between communication providers, and technologies related to the mobility management apparatus.

### BRIEF DESCRIPTION OF DRAWINGS

FIG. 1 is a block diagram illustrating a configuration of a mobility management apparatus in accordance with a first example embodiment.

FIG. 2 is a flowchart showing a flow of a mobility management method in accordance with the first example embodiment.

FIG. 3 is a block diagram illustrating a configuration of a mobility management system in accordance with a second example embodiment.

FIG. 4 is a flowchart showing a flow of a mobility management method in accordance with the second example embodiment.

FIG. 5 is a diagram illustrating an example of time zone information.

FIG. 6 is a diagram illustrating an example of relation information.

FIG. 7 is a diagram illustrating an example of relation information.

FIG. 8 is a diagram showing an example of a computer that executes an instruction of a program that is software to realize respective functions of apparatuses in accordance with each of example embodiments.

### DESCRIPTION OF EMBODIMENTS

### Problem to be Solved by Example Embodiments

The following will discuss a problem to be solved by example embodiments, and describes, as an example, a problem in a case where (i) a user whose home country (country of residence) is the United States visits Japan which is a roaming country and (ii) the user connects to a long term evolution (LTE) network.

It is conceivable that a mobility management apparatus that is located in the roaming country carries out, as a part of a series of processes of an LTE connection sequence (initial attach), a selection process for selecting a session management apparatus (for example, packet data network gateway (PGW)) as a connection destination.

It is also conceivable that a mobility management apparatus (e.g., mobility management entity (MME)) in the roaming country creates an FQDN query key on the basis of APN information that a user's terminal apparatus (UE) has. Further, it is conceivable that the mobility management apparatus inquires, on the basis of the query key, a plurality of session management apparatuses (PGWs) of a network information management apparatus (DNS). The plurality of session management apparatuses here are each a candidate of the connection destination in the home country.

It is also conceivable that a storage section of the network information management apparatus stores information related to the plurality of session management apparatuses that are each a candidate of the connection destination. The information is associated with connection priority information of the session management apparatuses. In addition, it is conceivable that the mobility management apparatus selects, as the connection destination, a session management apparatus having a high connection priority, on the basis of the connection priority information of the session management apparatuses.

In addition, it is conceivable that in a case where the connection destination is congested in an attempt to establish a communication connection with a connection destination in the home country, the mobility management apparatus receives error response information. The error response information is a response, from the connection destination, for replying that a communication connection error occurred due to congestion. It is also conceivable that then, the mobility management apparatus re-selects another session management apparatus as the connection destination and establishes a communication connection with the another session management apparatus.

However, in such a configuration, an additional amount of time is taken for a process for re-selecting another connection destination. Then, a time to establish a connection with a connection destination becomes longer. Accordingly, there is a problem in that user experience (UX) deteriorates. In light of the above, one of problems to be solved by an example embodiment is to provide a mobility management apparatus capable of shortening, by reducing the occurrence of the process of re-selecting another connection destination as described above, a time to establish a communication connection with a connection destination via a network that is connected on the basis of cross-border cooperation between communication providers, and technologies related to such a mobility management apparatus.

### First Example Embodiment

The following will discuss a first example embodiment of the present invention in detail, with reference to drawings. The present example embodiment is an embodiment that serves as a base for example embodiments which will be described later.

(Configuration of Mobility Management Apparatus 10)

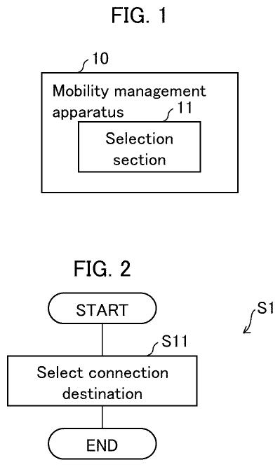

The following will discuss a configuration of a mobility management apparatus 10 in accordance with the present example embodiment, with reference to FIG. 1. FIG. 1 is a block diagram illustrating the configuration of the mobility management apparatus 10. The mobility management apparatus 10 includes a selection section (selection means) 11, as illustrated in FIG. 1.

The mobility management apparatus 10 establishes a communication connection, via a network connected on the basis of cooperation between communication providers in a roaming country and a home country which has a plurality of time zones, with a connection destination that is selected from a plurality of session management apparatuses in the home country. The selection section 11 selects the connection destination on the basis of time zone information that indicates a time zone to which each of the plurality of session management apparatuses belongs.

The term “home country” here refers to a country in which a user's terminal apparatus (not illustrate) is under contract, for example, user's country of residence (user's country). The term “roaming country” refers to a country in which the mobility management apparatus 10 that establishes an international roaming connection is located, for example, a country that a user visits. The international roaming connection is established via a network that is connected on the basis of cross-border cooperation between communication providers. The term “time zone” refers to a region where the same standard time is used. The session management apparatus will be described in detail in the second example embodiment.

(Flow of Mobility Management Method S1)

The following will discuss a flow of a mobility management method S1 in accordance with the present example embodiment, with reference to FIG. 2. FIG. 2 is a flowchart showing a flow of the mobility management method S1.

As illustrated in FIG. 2, the mobility management method S1 includes step S11. The following will discuss, as an example, a case where the mobility management method S1 is carried out by sections of the mobility management apparatus 10, but the mobility management method S1 may be carried out by at least one processor. The at least one processor may be provided in the mobility management apparatus 10, in another apparatus, or in a plurality of apparatuses.

In step S11, the selection section 11 of the mobility management apparatus 10 selects a session management apparatus as a connection destination, on the basis of time zone information that indicates a plurality of time zones to which a plurality of session management apparatuses belong.

(Advantageous Effects of First Example Embodiment) The present example embodiment employs a configuration in which: the mobility management apparatus 10 establishes a communication connection, via a network connected on the basis of cooperation between communication providers in a roaming country and a home country which has a plurality of time zones, with a connection destination that is selected from a plurality of session management apparatuses in the home country; and the selection section 11 selects the connection destination on the basis of the time zone information.

This configuration allows the selection section 11 to select, as the connection destination on the basis of a time difference with each of the plurality of time zones in the home country, a session management apparatus that belongs to a time zone in a light-load time period. Accordingly, the present example embodiment advantageously makes it possible to reduce the occurrence of a process for re-selecting another connection destination as described above and to shorten a time to establish a communication connection with a connection destination via a network that is connected on the basis of cross-border cooperation between communication providers.

(Mobility management program) In a case where the mobility management apparatus 10 is configured by a computer, it is possible to realize the function of the mobility management apparatus 10 by the following mobility management program that is stored in a memory to which the computer refers.

The mobility management program is for establishing a communication connection, via a network connected on the basis of cooperation between communication providers in a roaming country and a home country which has a plurality of time zones, with a connection destination that is selected from a plurality of session management apparatuses in the home country, the mobility management program causing a computer to function as the selection section 11 that selects the connection destination on the basis of time zone information.

The computer carries out the above-described mobility management method S1 by reading the mobility management program from the memory and executing the mobility management program, so that it is possible to yield an advantageous effect which is the same as that obtained by the mobility management method S1.

### Second Example Embodiment

The following will discuss a second example embodiment of the present invention in detail, with reference to drawings. Note that components having the same functions as those described in the first example embodiment are denoted by the same reference numerals, and a description thereof will be omitted accordingly.

(Configuration of Mobility Management System 1)

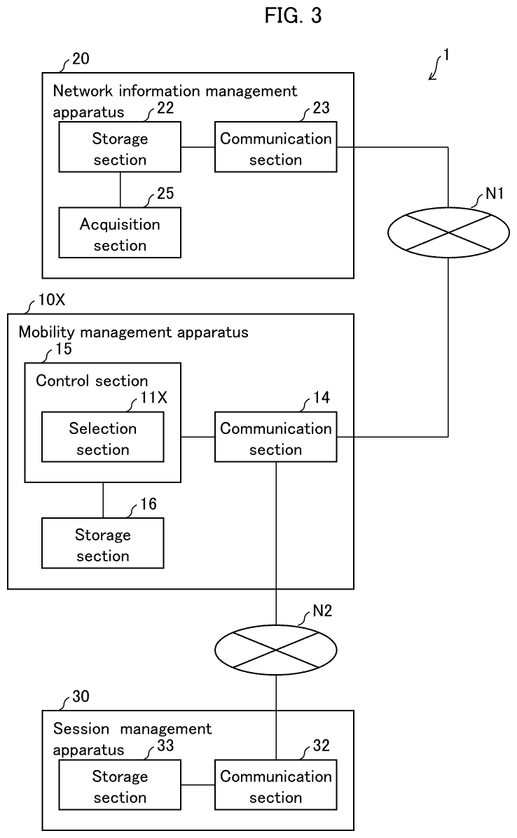

The following will discuss a configuration of the mobility management system 1 in accordance with the present example embodiment, with reference to FIG. 3. FIG. 3 is a block diagram illustrating the configuration of the mobility management system 1. As illustrated in FIG. 3, the mobility management system 1 includes a mobility management apparatus 10X, a network information management apparatus 20 and a session management apparatus 30.

The network information management apparatus 20 and the mobility management apparatus 10X are connected to each other via a network N1 so as to be capable of communicating with each other. The mobility management apparatus 10X and the session management apparatus 30 are connected to each other via a network N2 so as to be capable of communicating with each other. The networks N1 and N2 include mobile networks of communication providers.

In an example illustrated in FIG. 3, only a connection destination among a plurality of session management apparatuses is illustrated as the session management apparatus 30, and illustration of the other session management apparatuses that are not connection destinations is omitted. In the example illustrate in FIG. 3, one apparatus for each of the above apparatuses is shown. However, the number of apparatuses corresponding to each of the above-described apparatuses may be two or more.

(Configuration of Mobility Management Apparatus 10X)

The mobility management apparatus 10X is, for example, an MME. In a case where the mobility management apparatus 10X is an MME, the mobility management apparatus 10X functions as a gateway. In this case, the mobility management apparatus 10X handles control signals of user equipment (UE) that is a terminal apparatus of a user, and carries out management of terminal information and authentication (security control), management of a transfer path of packet data of the user, and/or the like. The mobility management apparatus 10X also functions as an apparatus that manages position information of the UE and the base station and controls connection of the UE and the base station.

The mobility management apparatus 10X includes a communication section 14, a control section 15, and a storage section 16.

The communication section 14 sends, to the communication section 23 of the network information management apparatus 20, query information regarding a plurality of session management apparatuses that are candidates of the connection destination. The communication section 14 receives, from the communication section 23 of the network information management apparatus 20, time zone information indicating a plurality of time zones to which the plurality of session management apparatuses belong. The communication section 14 establishes a communication connection with the communication section 32 of the session management apparatus 30 that is the connection destination.

The control section 15 carries out overall control of sections of the mobility management apparatus 10X, and manages connection destination information of the mobility management apparatus 10X (for example, MME). The control section 15 includes a selection section 11X. The selection section 11X selects, on the basis of the time zone information, the session management apparatus 30 that is the connection destination. The selection section 11X will be described later in detail in the section of “Flow of mobility management method SiX”.

The storage section 16 stores various data to which the control section 15 refers. The storage section 16 stores in advance relation information indicating a relation between each of time periods of a day in the home country and a communication data amount of the plurality of session management apparatuses. The selection section 11X of the control section 15 refers to the relation information. The storage section 16 may further store information regarding a user, such as Home Subscriber Server (HSS), that is required for using a communication network of the terminal apparatus of the user.

(Configuration of Network Information Management Apparatus 20)

The network information management apparatus 20 includes a domain name system (DNS) or the like. In a case where the network information management apparatus 20 is a DNS, the network information management apparatus 20 functions as a system that manages a domain name and an IP address of the user in association with each other.

The network information management apparatus 20 includes a communication section 23, a storage section 22, and an acquisition section 25. The communication section 23 receives, from the communication section 14 of the mobility management apparatus 10X, the query information regarding the plurality of session management apparatuses. Further, the communication section 23 sends the time zone information to the communication section 14 of the mobility management apparatus 10X. The storage section 22 stores various data such as the time zone information that the communication section 23 sends. The acquisition section 25 acquires various data such as the time zone information.

(Configuration of Session Management Apparatus 30)

The session management apparatus 30 includes, for example, a node such as a PGW. In a case where the session management apparatus 30 is a PGW, the session management apparatus 30 functions as a gateway for connection to an external network.

Specifically, the session management apparatus 30 has a function of connecting an evolved packet core (EPC) that is a 4G packet core apparatus and an external network (for example, the Internet) to each other. The session management apparatus 30 also carries out, for example, processes of forwarding packets, granting (assigning) an IP address to the terminal apparatus (UE) of the user, such as a portable terminal (for example, a smartphone), and breaking a connection to the network. The session management apparatus 30 is a connection point with a packed data network (PDN). The session management apparatus 30 also functions as a gateway that grants an IP address and forwards packets to the communication section 14 (SGW) of the mobility management apparatus 10X. The session management apparatus 30 also manages bandwidth control for each service and manages the IP address to be granted to the terminal apparatus of the user.

The session management apparatus 30 includes the communication section 32 and a storage section 33. The communication section 32 establishes a communication connection with the communication section 14 of the mobility management apparatus 10X. The session management apparatus 30 functions as a gateway that, for example, forwards packets to a serving gateway (SGW). The storage section 33 stores various data.

(Flow of Mobility Management Method SiX)

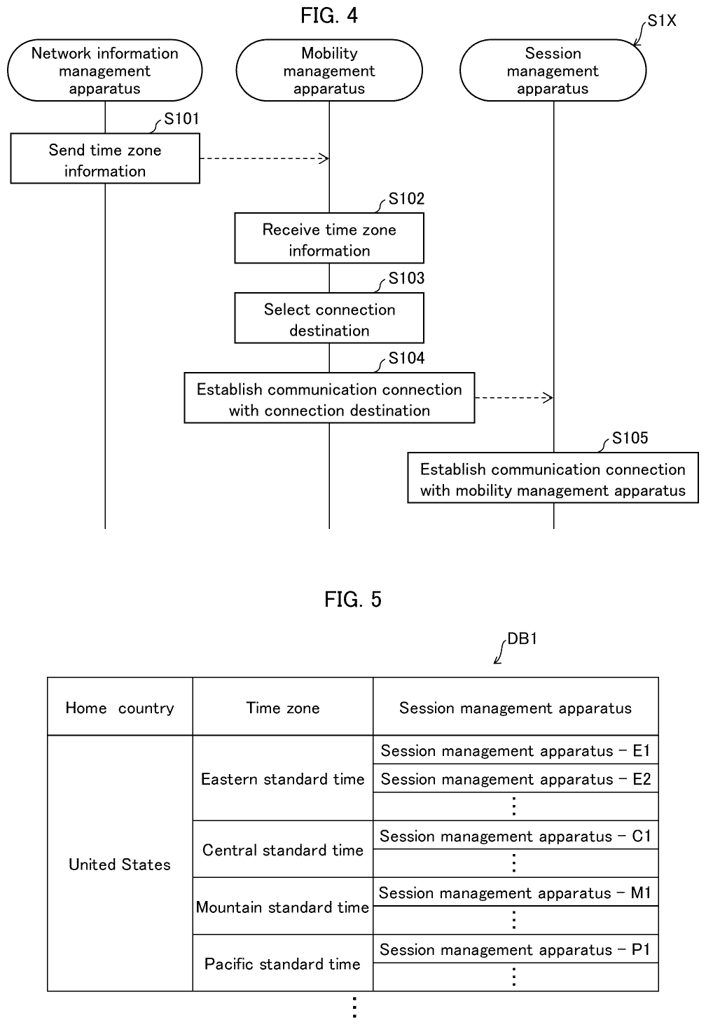

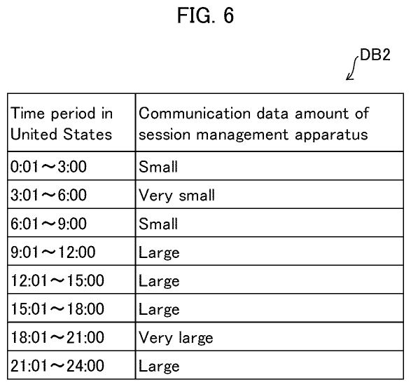

The following will discuss a flow of a mobility management method SiX in accordance with the present example embodiment, with reference to FIGS. 4 to 6. FIG. 4 is a flowchart showing the flow of the mobility management method SiX. FIG. 5 is a diagram illustrating an example of the time zone information. FIG. 6 is a diagram illustrating an example of the relation information.

As illustrated in FIG. 4, the mobility management method SiX includes steps S101, S102, S103, S104, and S105. The following will discuss, as an example, a case where sections of the mobility management method SiX is carried out by sections of the mobility management apparatus 10X. The mobility management method SiX may be carried out by at least one processor. The at least one processor may be provided in the mobility management apparatus 10X, in another apparatus, or in a plurality of apparatuses.

In FIG. 4, the acquisition section 25 of the network information management apparatus 20 acquires, in advance, the time zone information by receiving or receiving an input of the time zone information from an external holder or the like that has the time zone information, and the storage section 22 of the network information management apparatus 20 stores, in advance, the time zone information. The communication section 14 of the mobility management apparatus 10X sends, in advance to the communication section 23 of the network information management apparatus 20, query information regarding the plurality of session management apparatuses that are candidates of the connection destination.

Further, the example illustrated in FIG. 4 assumes a case where a user whose home country (country of residence) is the United States visits Japan which is a roaming country, and the user carries out international roaming connection via a network that is connected on the basis of cross-border cooperation between communication providers. In this case, the terminal apparatus of the user and the mobility management apparatus 10X start a connection from Japan, which is the roaming country, to an LTE network. As a result, the terminal apparatus (UE) of the user and the mobility management apparatus 10X are connected to each other via a radio network or the like that provides LTE, such as an evolved universal terrestrial radio network (E-UTRAN). Further, the mobility management apparatus 10X and the network information management apparatus 20 are connected to each other via the network N1.

The communication section 14 of the mobility management apparatus 10X in the roaming country creates a fully qualified domain name (FQDN) query key on the basis of access point name (APN) information that the terminal apparatus of the user has. The communication section 14 of the mobility management apparatus 10X sends, to the communication section 23 of the network information management apparatus 20 on the basis of the query key, the query information regarding the plurality of session management apparatuses of a home provider in the home country.

(Step S101)

In step S101, the communication section 23 of the network information management apparatus 20 sends, to the communication section 14 of the mobility management apparatus 10, time zone information indicating a plurality of time zones to which a plurality of session management apparatuses belong.

For example, in a case where the communication section 23 of the network information management apparatus 20 receives the query information from the communication section 14 of the mobility management apparatus 10X, the communication section 23 of the network information management apparatus 20 sends the time zone information to the communication section 14 of the mobility management apparatus 10.

The time zone information can be, for example, a database which has a table that indicates a relation between (i) a plurality of time zones of the home country and (ii) a plurality of session management apparatuses which are candidates of the connection destination and each of which belongs to a corresponding one of the time zones, as shown in time zone information DB1 of FIG. 5.

(Step S102)

In step S102, the communication section 14 of the mobility management apparatus 10X receives, from the communication section 23 of the network information management apparatus 20, the time zone information indicating the plurality of time zones to which the plurality of session management apparatuses belong.

(Step S103)

In step S103, the selection section 11X of the mobility management apparatus 10X selects a session management apparatus 30 as the connection destination, on the basis of the time zone information that indicates the plurality of time zones to which the plurality of session management apparatuses belong.

For example, the selection section 11X refers to the time zone information and calculates a time period of a day in a time zone to which each of the plurality of session management apparatuses in the home country that are candidates of the connection destination belongs. Next, the selection section 11X may select, from among the plurality of session management apparatuses, a session management apparatus that is in a time period of a day suitable for establishing a communication connection. The time period of a day suitable for establishing a communication connection may be predetermined, and examples of the time period of a day include a light-load time period in which the communication data amount is small.

The selection section 11X may select the session management apparatus 30 as the connection destination, further on the basis of relation information indicating a relation between each of a plurality of time periods of a day in the home country and the communication data amount of the plurality of session management apparatuses.

For example, the selection section 11X calculates time which is in each of the plurality of time zones in the home country and which corresponds to time in the roaming country. Next, the selection section 11X refers to the relation information and calculates the communication data amount of the plurality of session management apparatuses in a time period of a day to which the time in each of the plurality of time zones belongs. The selection section 11X may select, as the session management apparatus that is in the time period of a day suitable for establishing a communication connection, a session management apparatus that is in a light-load time period having a small communication data amount from among the plurality of session management apparatuses.

(Example of Step S103)

The following will discuss an example of step S103. In this example, the selection section 11X selects a connection destination by referring to the time zone information DB1 illustrated in FIG. 5 and relation information DB2 that indicates a relation illustrated in FIG. 6 between each of the plurality of time periods of a day in the home country and a communication data amount of session management apparatuses.

Here, the relation information DB2 illustrated in FIG. 6 is a database that indicates a relation between (i) each of a plurality of time periods of a day that are common to the home country but that are not for each time zone in the home country and (ii) the communication data amount of the session management apparatuses. The relation information DB2 is stored in advance in the storage section 16 of the mobility management apparatus 10X. Accordingly, the “communication data amount” of the relation information DB2 is not the present communication data amount of the plurality of session management apparatuses. An example of the “communication data amount” is an average value of past communication data amounts of the plurality of session management apparatuses in a predetermined period.

The term “communication data amount” in the relation information DB2 in FIG. 6 refers to a traffic amount. The term “small” indicates that the communication data amount is a first threshold value or more and less than a second threshold value (the first and second thresholds are predetermined thresholds), and that the time period corresponding to the communication data amount is an off-peak period. The term “very small” indicates that the communication data amount is less than the first threshold value (the first threshold is a predetermined threshold), and that the time period corresponding to the communication data amount is in an extreme off-peak period. The term “large” indicates that the communication data amount is a third threshold value or more and less than a fourth threshold value (the third and fourth thresholds are predetermined thresholds), and that the communication data amount is so large that congestion may occur. The term “very large” indicates that the communication data amount is the fourth threshold value or more (the fourth threshold is a predetermined threshold), and that the communication data amount is so large that congestion is probably occurring.

As illustrated in FIG. 6, in a period of 0:01 to 9:00, which is outside business hours, a user rarely uses a terminal apparatus. Accordingly, the communication data amount of the session management apparatus is small. In a midnight time period of 3:01 to 6:00, the communication data amount is particularly small.

The selection section 11X may select the session management apparatus 30 as the connection destination, further on the basis of the time for each time zone in the home country. For example, the selection section 11X may select the session management apparatus 30 as the connection destination, on the basis of communication data amounts of a plurality of session management apparatuses in time periods of a day that time, which is in each of the plurality of time zones in the home country and which corresponds to time in the time zone in the roaming country, belongs to.

In this case, the selection section 11X refers to the time zone information DB1 in FIG. 5 and calculates the time which is in each of the plurality of time zones in the United States that is the home country and which corresponds to the time in Japan that is the roaming country. Specifically, the selection section 11X calculates time of the eastern standard time (EST), time of the central standard time (CST), time of the mountain standard time (MST) and time of the pacific standard time (PST). In an example, if the time in Japan is 8:01, the selection section 11X calculates the time of the eastern standard time as 18:01, the time of the central standard time as 17:01, the time of the mountain standard time 16:01, and the time of the pacific standard time as 15:01.

Next, the selection section 11X refers to the time zone information DB1 and the relation information DB2, and infers the communication data amount of the plurality of session management apparatuses in a time period of a day to which each of the plurality of time zones in the United States belongs.

For example, the selection section 11X infers that the communication data amounts of the session management apparatus—E1 and the session management apparatus—E2 in the time period of 18:01 to 21:00, to which the time 18:01 of the eastern standard time belongs, are “very large”. The selection section 11X infers that the communication data amount of the session management apparatus—C1 in the time period of 15:01 to 18:00, to which the time 17:01 of the central standard time belongs, is “small”. The selection section 11X infers that the communication data amount of the session management apparatus—M1 in the time period of 15:01 to 18:00, to which the time 16:01 of the mountain standard time belongs, is “small”. The selection section 11X infers that the communication data amount of the session management apparatus—P1 in the time period of 15:01 to 18:00, to which the time 15:01 of the pacific standard time belongs, is “small”.

The selection section 11X selects, as the session management apparatus 30 that is the connection destination, a session management apparatus that belongs to a time zone in a time period of a day corresponding to the off-peak period. For example, on the basis of the communication data amount in a time period of a day that the time, which is in each of the plurality of time zones in the home country and which corresponds to the time in the time zone in the roaming country, belongs to, the selection section 11X may select, as the connection destination, a session management apparatus whose communication data amount is less than the predetermined threshold value.

In this configuration, the connection destination that is selected by the selection section 11X changes in accordance with a threshold value set by the user. For example, in a case where a predetermined threshold value set by the user is the fourth threshold value, the selection section 11X may select, as the connection destination, a session management apparatus other than a heavy-load session management apparatus whose communication data amount is “very large”. On the other hand, in a case where the predetermined threshold value set by the user is the third threshold, the selection section 11X may select, as the connection destination, a light-load session management apparatus whose communication data amount is “small” or “extremely small”. In the configuration, the selection section 11X thus selects, in accordance with the threshold value set by the user, a desired connection destination for the user.

In the above-described example, the following session management apparatuses are each a candidate of the connection destination and has a “large” communication data amount: the session management apparatus—P1 that belongs to the time zone of the pacific standard time; the session management apparatus—C1 that belongs to the time zone of the central standard time; and the session management apparatus—M1 that belongs to the time zone of the mountain standard time.

In this way, in a case where there are a plurality of session management apparatuses as candidates of the connection destination whose communication data amount is not “very large”, the selection section 11X may select, as the connection destination a session management apparatus whose the communication data amount is the smallest from among the session management apparatuses whose communication data amount is less than the fourth threshold value. As a result, even in a case where there are a plurality of session management apparatuses that are candidates of the light-load connection destination and that has a communication data amount less than the threshold value, the selection section 11X selects, as the session management apparatus that becomes the connection destination, a lowest-load session management apparatus whose communication data amount is the smallest.

In the above-described example, the following session management apparatuses are each a candidate of the connection destination and has the smallest communication data amount: the session management apparatus—P1 that belongs to the time zone of the pacific standard time; the session management apparatus—C1 that belongs to the time zone of the central standard time; and the session management apparatus—M1 that belongs to the time zone of the mountain standard time.

In a case where there are a plurality of session management apparatuses that are candidates of the connection destination whose communication data amount is the smallest, the selection section 11X may select the connection destination randomly or on the basis of session management apparatus number. For example, the selection section 11X may randomly select, as the connection destination, a session management apparatus—P1 that belongs to the time zone of the pacific standard time, or may select, as the connection destination, the session management apparatus—C1 whose number is the smallest. In this case, the selection section 11X may select, as the connection destination, the session management apparatus—P1 or the session management apparatus—C1, by selecting an IP address of the session management apparatus—P1 or the session management apparatus—C1.

As a result, even in a case where there are a plurality of session management apparatuses as candidates of the connection destination whose communication data amount is the smallest, the selection section 11X selects the session management apparatus 30 as the connection destination on the basis of a predetermined rule. Accordingly, even in a case where there are a plurality of session management apparatuses as candidates of the connection destination whose communication data amount is the smallest, the selection section 11X automatically selects the connection destination.

(Step S104)

In step S104, the communication section 14 of the mobility management apparatus 10X establishes a communication connection with the communication section 32 of the session management apparatus 30 that is the connection destination.

For example, the communication section 14 of the mobility management apparatus 10X in Japan, which is the roaming country, establishes a communication connection, via a network N2 that is connected on the basis of cross-border cooperation between communication providers, with the communication section 32 of the session management apparatus 30 which is the connection destination in the home country.

In step S104, in a case where the communication section 14 of the mobility management apparatus 10X cannot establish a communication connection with the communication section 32 of the session management apparatus 30 as the connection destination, the selection section 11X may select another connection destination from among the session management apparatuses each belonging to a time zone different from a time zone of the connection destination.

For example, the following will discuss a case in which the session management apparatus—E1 that belongs to the time zone of the eastern standard time is congested and the communication section 14 of the MME that is the mobility management apparatus 10X cannot establish a communication connection with the communication section 32 of the session management apparatus—E1. In this case, the selection section 11X may select, as another connection destination, the session management apparatus—P1 that belongs to the time zone in the pacific standard time that has a time difference of three hours from the time zone of the eastern standard time.

(Step S105)

In step S105, the communication section 32 of the session management apparatus 30 that is the connection destination establishes a communication connection with the communication section 14 of the mobility management apparatus 10X.

For example, the communication section 14 of the mobility management apparatus 10X that is located in Japan, which is the roaming country, establishes an international roaming connection. The communication section 14 thus establishes a communication connection with the communication section 32 of the session management apparatus 30 that is the connection destination in the United States, which is the home country. In this case, when establishment of the communication connection between the communication section 32 and the communication section 14 is completed, a roaming service is started.

(Advantageous Effects of Second Example Embodiment)

The present example embodiment employs a configuration in which the storage section 22 of the network information management apparatus 20 stores time zone information. The time zone information indicates a plurality of time zones to which a plurality of session management apparatuses belong. Further, the present example embodiment employs a configuration in which the communication section 23 of the network information management apparatus 20 sends the time zone information to the communication section 14 of the mobility management apparatus 10X, and the communication section 14 receives the time zone information from the communication section 23.

This configuration differs from the technology disclosed in Patent Literature 1 in that the storage section 22 stores the time zone information and the communication section 14 receives the time zone information from the communication section 23. Therefore, according to the present example embodiment, the mobility management apparatus 10X achieves the following effect in addition to the effects of the first example embodiment. That is, it is possible to easily acquire the time zone information that the selection section 11X refers to when selecting the session management apparatus 30 as the connection destination.

Further, the present example embodiment employs a configuration in which the selection section 11X of the mobility management apparatus 10X selects the connection destination on the basis of the time zone information and the communication section 14 of the mobility management apparatus 10X establishes a communication connection with the connection destination.

This configuration allows the selection section 11X to select, as the connection destination on the basis of the time difference with each of the plurality of time zones in the home country, a session management apparatus that belongs to a time zone in a light-load time period. Accordingly, the present example embodiment advantageously makes it possible to reduce the occurrence of a process as described above for re-selecting another connection destination and to shorten a time to establish a communication connection with a connection destination via a network that is connected on the basis of cross-border cooperation between communication providers.

Further, the present example embodiment employs a configuration in which the selection section 11X of the mobility management apparatus 10X selects the connection destination, further on the basis of relation information indicating a relation between each of time periods of a day in the home country and a communication data amount of a plurality of session management apparatuses.

According to the above configuration, for example, the selection section 11X selects, as the connection destination, on the basis of the communication data amount of the plurality of session management apparatuses in a time period of a day that the time, which is in each of the plurality of time zones in the home country and which corresponds to the time in the roaming country, belongs to. Accordingly, in the present example embodiment, the selection section 11X easily selects, as the connection destination, a session management apparatus in the light-load time period in which the communication data amount is small. As a result, it is possible to achieve the following effect in addition to the effects of the first example embodiment. That is, it is possible to more easily avoid the risk of the occurrence of error response and a process of re-selecting a light-load session management apparatus due to selection of a heavy-load session management apparatus that is being congested.

Further, the present example embodiment employs a configuration in which, in a case where the communication section 14 of the mobility management apparatus 10X cannot establish a communication connection with the session management apparatus 30 as the connection destination, the selection section 11X select another connection destination from among the session management apparatuses each belonging to a time zone different from a time zone of the connection destination.

This configuration allows, for example, the selection section 11X to re-select another connection destination from among the session management apparatuses that belong to a time zone(s) different from the time zone of the connection destination in a time period in which congestion is occurring under heavy load. As a result, it is possible to achieve the following effect in addition to the effects of the first example embodiment. That is, it is possible to easily re-select another connection destination in a light-load time period which is in another time zone and in which the communication data amount is small.

Further, the present example embodiment employs a configuration in which the mobility management apparatus 1X is an MME, the network information management apparatus 20 is a DNS, and the session management apparatus 30 is a PGW.

This configuration allows the mobility management system 1 to be applied to a 4G core network. Therefore, in the present example embodiment, it is possible to achieve the following effect in addition to the effects of the first example embodiment. That is, it is possible to solve a problem that a longer time is taken to establish a connection with a connection destination by selecting the another connection destination, which is likely to occur in a case where the above-described system is applied to a 4G core network.

### First Variation

In the above-described example, the mobility management apparatus 10X is an MME, the network information management apparatus 20 is a DNS, and the session management apparatus 30 is a PGW. However, the present example embodiment is not limited to this configuration. The mobility management apparatus 10X may be an access and mobility management function (AMF) apparatus. The network information management apparatus 20 may be a network repository function (NRF) apparatus. The session management apparatus 30 may be a session management function (SMF) apparatus.

In a case where the mobility management apparatus 10X is an AMF apparatus, the mobility management apparatus 10X may function as an apparatus that has a mobility management function such as location information management or authentication of user terminal information.

In a case where the network information management apparatus 20 is an NRF apparatus, the network information management apparatus 20 may function as an apparatus that has the functions of registering and authorizing services of respective network functions (NFs) and finding a necessary NF service. In this case, unlike a case where the network information management apparatus 20 is a DNS, the acquisition section 25 of the network information management apparatus 20 may acquire the time zone information by collecting the time zone information but not by receiving or receiving an input of the time zone information from an external holder or the like that has the time zone information.

In a case where the session management apparatus 30 is an SMF apparatus, the session management apparatus 30 may function as an apparatus that controls management of a virtual communication path for exchanging data or a session that is data exchange itself. The session management apparatus 30 may function as an apparatus which sets a transfer path for data that uses an application or which makes the transfer path open.

### Advantageous Effects of First Variation

The first variation employs a configuration in which the mobility management apparatus 10X is an AMF apparatus, the network information management apparatus 20 is an NRF apparatus, and the session management apparatus 30 is an SMF apparatus.

This configuration allows the mobility management system 1 to be applied to a 5G core network. Therefore, in the present first variation, it is possible to achieve the following effect in addition to the effects of the first example embodiment. That is, it is possible to solve a problem that a time to establish a connection with a connection destination is longer due to re-selection of another connection destination, which is likely to occur in a case where the above-described system is applied to a 5G core network. Further, in this configuration, the network information management apparatus 20 that is an NRF apparatus, unlike a DNS, acquires the time zone information by collecting the time zone information but not by receiving or receiving an input of the time zone information from an external holder or the like that has the time zone information. Accordingly, in the first variation, it is possible to achieve an effect that the network information management apparatus 20 can automatically acquire the time zone information.

### Second Variation

In the example described above, the relation information is a database that indicates, as illustrated in the relation information DB2 in FIG. 6, a relation between each of time periods of a day common to a home country and a communication data amount of session management apparatuses. However, in the present example embodiment, the relation information may be information that indicates a relation between each of time periods of a day and a communication data amount of a plurality of session management apparatuses for each of the plurality of time zones in the home country.

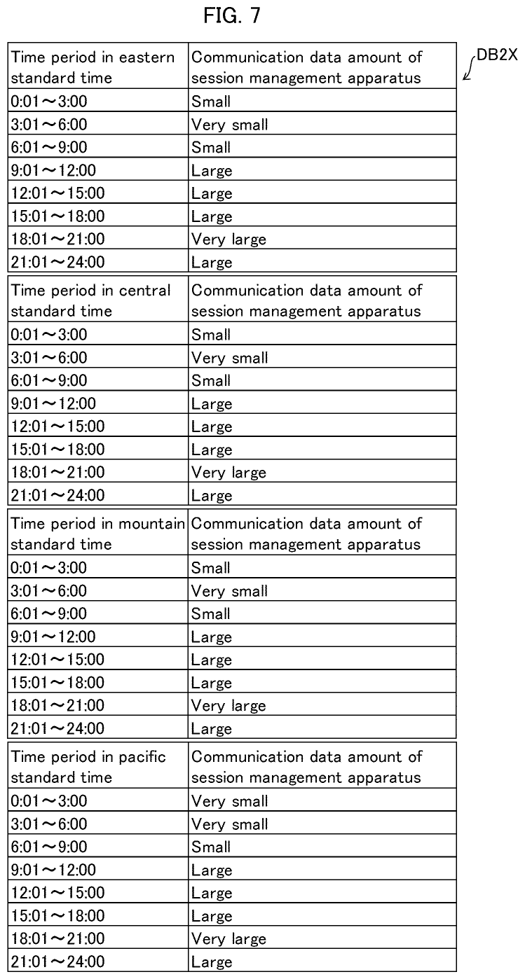

The following will discuss the second variation, with reference to FIG. 7. FIG. 7 is a diagram illustrating an example of the relation information. As illustrated in relation information DB2X in FIG. 7, the relation information may be a database that includes a table which indicates a relation between each of the time periods of a day and the communication data amount of the session management apparatuses for each of the plurality of time zones in the home country.

In the example illustrated in FIG. 7, the relation information DB2X is different from the relation information DB2 illustrated in FIG. 6 in that the time periods of a day in the home country are time periods of a day for each of the plurality of time zones in the home country. Further, in the relation information DB2X, the communication data amount of session management apparatuses in a time period of 0:01 to 3:00 in the time zone of the pacific standard time is smaller than communication data amounts of session management apparatuses in the same time period of 0:01 to 3:00 in the other time zones. Accordingly, the selection section 11X of the mobility management apparatus 10X can easily select, as the connection destination, a session management apparatus whose communication data amount is the smallest, in a case where the time in the United States which is the home country is in a time period of 0:01 to 3:00 and the time corresponds to the time in Japan that is the roaming country.

### Advantageous Effects of Second Variation

As described above, the second variation employs a configuration in which the relation information is information that indicates a relation between each of time periods of a day and the communication data amount of the plurality of session management apparatuses for each of the plurality of time zones in the home country.

This configuration allows the selection section 11X of the mobility management apparatus 10X to select the connection destination on the basis of the communication data amount of the session management apparatuses in each of the time periods of a day for each of the plurality of time zones in the home country. Accordingly, the second variation can achieve the effect that a more appropriate connection destination can be more easily selected.

### Third Variation

In the example described above, the selection section 11X of the mobility management apparatus 10X selects, as the connection destination, a session management apparatus whose communication data amount is the smallest from among session management apparatuses whose communication data amount is less than the threshold value.

However, in the present example embodiment, the selection section 11X may select, on the basis of information inputted by a user, the connection destination from among the session management apparatuses whose communication data amount is less than the threshold value. A method for acquiring the information which is inputted by a user and to which the selection section 11X refers is not particularly limited. For example, the information inputted by the user may be received by the communication section 14 of the mobility management apparatus 10X from a communication section of an external terminal apparatus (UE) of the user. The mobility management apparatus 10X further includes an input receiving section (not illustrated). Then, the input receiving section may receive an input from a user, so that the mobility management apparatus 10X may acquire information inputted by the user.

(Advantageous Effects of Third Variation)

The third variation employs a configuration in which the selection section 11X selects, on the basis of information inputted by a user, a connection destination from among session management apparatuses whose communication data amount is less than a threshold value.

In this configuration, even in a case where there are a plurality of light-load session management apparatuses whose communication data amount is less than the threshold value, the selection section 11X selects the connection destination on the basis of the information inputted by the user, in other words, substantially the user selects the connection destination. As a result, it is possible to achieve the following effect in addition to the effects of the first example embodiment. That is, it is possible to select a connection destination that a user desires.

<Software Implementation Example>

Part or all of functions of respective apparatuses constituting the mobility management system 1 can be realized by hardware provided in an integrated circuit (IC chip) or the like or can be alternatively realized by software.

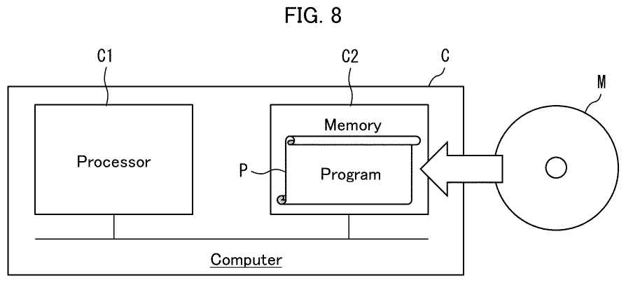

In the latter case, the respective apparatuses constituting the mobility management system 1 are realized by, for example, a computer that executes instructions of a program that is software realizing the foregoing functions. FIG. 8 illustrates an example of such a computer (hereinafter, referred to as “computer C”). The computer C includes at least one processor C1 and at least one memory C2. In the memory C2, a program P for causing the computer C to operate as the respective apparatuses constituting the mobility management system 1 is stored. In the computer C, the foregoing functions of the respective apparatuses constituting the mobility management system 1 can be realized by the processor C1 reading and executing the program P stored in the memory C2.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller or a combination thereof. Examples of the memory C2 encompass a flush memory, a hard disk drive (HDD), a solid state drive (SSD) or a combination thereof.

The computer C may further include a random access memory (RAM) in which the program P is loaded when executed and/or in which various data are temporarily stored. Moreover, the computer C may further include a communication interface for transmitting/receiving data to/from another apparatus. In addition, the computer C may further include an input/output interface for connecting an input-output apparatus(es) such as a keyboard, a mouse, a display, and/or a printer.

The program P can be stored in a non-transitory tangible storage medium M that can be read by the computer C. Examples of the storage medium M encompass a tape, a disk, a card, a semiconductor memory, and a programmable logic circuit. The computer C can obtain the program P via such a storage medium M. Further, the program P can be transmitted via a transmission medium. Examples of the transmission medium encompass a communication network or a broadcast wave. The computer C can obtain the program P via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can be described as, but not limited to, the following supplementary notes.

### Supplementary Note 1

A mobility management apparatus that establishes a communication connection, via a network connected on the basis of cooperation between communication providers in a roaming country and a home country which has a plurality of time zones, with a connection destination that is selected from a plurality of session management apparatuses in the home country,
the mobility management apparatus including a selection means for selecting the connection destination, on the basis of time zone information indicating a time zone to which each of the plurality of session management apparatuses belongs.

### Supplementary Note 2

The mobility management apparatus according to Supplementary Note 1, further including a communication means for receiving the time zone information from a network information management apparatus.

### Supplementary Note 3

The mobility management apparatus according to Supplementary Note 1 or 2, wherein the selection means selects the connection destination, further on the basis of relation information indicating a relation between each of time periods of a day in the home country and a communication data amount of the plurality of session management apparatuses.

### Supplementary Note 4

The mobility management apparatus according to any one of Supplementary notes 1 to 3, wherein the relation information indicates a relation between each of the time periods of a day in each of the plurality of time zones in the home country and the communication data amount of the plurality of session management apparatuses.

### Supplementary Note 5

The mobility management apparatus according to any one of Supplementary notes 1 to 4, wherein in a case where the mobility management apparatus cannot establish the communication connection with the connection destination, the selection means selects another connection destination from among the session management apparatuses each belonging to a time zone different from a time zone to which the connection destination belongs.

### Supplementary Note 6

The mobility management apparatus according to any one of Supplementary notes 2 to 5, wherein:
the mobility management apparatus is a mobility management entity (MME);
the network information management apparatus is a domain name system (DNS); and
the session management apparatus is a packet data network gateway (PGW).

### Supplementary Note 7

The mobility management apparatus according to any one of Supplementary notes 2 to 5, wherein:
the mobility management apparatus is an access and mobility management function (AMF) apparatus;
the network information management apparatus is a network repository function (NRF) apparatus; and
the session management apparatus is a session management function (SMF) apparatus.

### Supplementary Note 8

A mobility management system including a mobility management apparatus, a network information management apparatus and a plurality of session management apparatuses,
the mobility management apparatus being an apparatus that establishes a communication connection, via a network connected on the basis of cooperation between communication providers in a roaming country and a home country which has a plurality of time zones, with a connection destination that is selected from the plurality of session management apparatuses in the home country,
the mobility management apparatus including:
   a communication means for receiving, from the network information management apparatus, time zone information indicating a time zone to which each of the plurality of session management apparatuses belongs, and establishing a communication connection with the connection destination; and
   a selection means for selecting the connection destination, on the basis of the time zone information,
the network information management apparatus including
   a communication means for sending the time zone information to the communication means of the mobility management apparatus,
the session management apparatus including
   a communication means for establishing the communication connection with the communication means of the mobility management apparatus.

### Supplementary Note 9

A mobility management method for establishing a communication connection, via a network connected on the basis of cooperation between communication providers in a roaming country and a home country which has a plurality of time zones, with a connection destination that is selected from a plurality of session management apparatuses in the home country,
the method including selecting, by at least one processor, the connection destination, on the basis of time zone information indicating a time zone to which each of the plurality of session management apparatuses belongs.

### Supplementary Note 10

A mobility management program for establishing a communication connection, via a network connected on the basis of cooperation between communication providers in a roaming country and a home country which has a plurality of time zones, with a connection destination that is selected from a plurality of session management apparatuses in the home country,
the mobility management program causing a computer to function as a selection means for selecting the connection destination, on the basis of time zone information indicating a time zone to which each of the plurality of session management apparatuses belongs.

### Additional Remark 3

The mobility management apparatus may further include a memory. The memory may store therein a program for causing the processor to select the connection destination, on the basis of time zone information that indicates a time zone to which each of the plurality of session management apparatuses belongs. Further, the program can be stored in a non-transitory tangible storage medium that can be read by a computer.

### Additional Remark 4

The present invention makes it possible to shorten a time to establish a connection with a session management apparatus and improve an infrastructure. Therefore, the present invention can contribute to achievement of GOAL 9 “INDUSTRY, INNOVATION AND INFRASTRUCTURE (Build infrastructure for industrialization and innovation)” of Sustainable Development Goals (SDGs).

### REFERENCE SIGNS LIST

10, 10X mobility management apparatus
14, 23, 32 communication section (communication means)
11, 11X selection section (selection means)
20 network information management apparatus
30 session management apparatus
C1 processor
C2 memory
DB1 time zone information
DB2, DB2X relation information
S1, S1X mobility management method

1. A mobility management apparatus that establishes a communication connection, via a network connected on the basis of cooperation between communication providers in a roaming country and a home country which has a plurality of time zones, with a connection destination that is selected from a plurality of session management apparatuses in the home country,
the mobility management apparatus comprising at least one processor,
the at least one processor carrying out a selection process for selecting the connection destination, on the basis of time zone information indicating a time zone to which each of the plurality of session management apparatuses belongs.

2. The mobility management apparatus according to claim 1, wherein
the at least one processor further carries out a communication process for receiving the time zone information from a network information management apparatus.

3. The mobility management apparatus according to claim 2, wherein
in the selection process, the at least one processor selects the connection destination, further on the basis of relation information indicating a relation between each of time periods of a day in the home country and a communication data amount of the plurality of session management apparatuses.

4. The mobility management apparatus according to claim 3, wherein
the relation information indicates a relation between each of the time periods of a day in each of the plurality of time zones in the home country and the communication data amount of the plurality of session management apparatuses.

5. The mobility management apparatus according to claim 4, wherein
in a case where the mobility management apparatus cannot establish the communication connection with the connection destination, the at least one processor selects, in the selection process, another connection destination from among the session management apparatuses each belonging to a time zone different from a time zone to which the connection destination belongs.

6. The mobility management apparatus according to claim 2, wherein:
the mobility management apparatus is a mobility management entity (MME);
the network information management apparatus is a domain name system (DNS); and
the session management apparatus is a packet data network gateway (PGW).

7. The mobility management apparatus according to claim 2, wherein:
the mobility management apparatus is an access and mobility management function (AMF) apparatus;
the network information management apparatus is a network repository function (NRF) apparatus; and
the session management apparatus is a session management function (SMF) apparatus.

8. A mobility management system comprising a mobility management apparatus, a network information management apparatus and a plurality of session management apparatuses,
the mobility management apparatus being an apparatus that establishes a communication connection, via a network connected on the basis of cooperation between communication providers in a roaming country and a home country which has a plurality of time zones, with a connection destination that is selected from the plurality of session management apparatuses in the home country,
the mobility management apparatus including at least one processor,
the at least one processor carrying out:
a communication process for receiving, from the network information management apparatus, time zone information indicating a time zone to which each of the plurality of session management apparatuses belongs, and establishing a communication connection with the connection destination; and
a selection process for selecting the connection destination, on the basis of the time zone information,
the network information management apparatus carrying out
a communication process for sending the time zone information to the mobility management apparatus,
the session management apparatus carrying out
a communication process for establishing the communication connection with the mobility management apparatus.

9. The mobility management system according to claim 8, wherein
in the selection process, the at least one processor selects the connection destination, further on the basis of relation information indicating a relation between each of time periods of a day in the home country and a communication data amount of the plurality of session management apparatuses.

10. The mobility management system according to claim 9, wherein
the relation information indicates a relation between each of the time periods of a day in each of the plurality of time zones in the home country and the communication data amount of the plurality of session management apparatuses.

11. The mobility management system according to claim 10, wherein
in a case where the mobility management apparatus cannot establish the communication connection with the connection destination, the at least one processor selects, in the selection process, another connection destination from among the session management apparatuses each belonging to a time zone different from a time zone to which the connection destination belongs.

12. The mobility management system according to claim 8, wherein:
the mobility management apparatus is a mobility management entity (MME);
the network information management apparatus is a domain name system (DNS); and
the session management apparatus is a packet data network gateway (PGW).

13. The mobility management system according to claim 8, wherein:
the mobility management apparatus is an access and mobility management function (AMF) apparatus;
the network information management apparatus is a network repository function (NRF) apparatus; and
the session management apparatus is a session management function (SMF) apparatus.

14. A mobility management method for establishing a communication connection, via a network connected on the basis of cooperation between communication providers in a roaming country and a home country which has a plurality of time zones, with a connection destination that is selected from a plurality of session management apparatuses in the home country,
the method comprising selecting, by at least one processor, the connection destination, on the basis of time zone information indicating a time zone to which each of the plurality of session management apparatuses belongs.

15. The mobility management method according to claim 14, further comprising receiving the time zone information from a network information management apparatus.

16. The mobility management method according to claim 15, wherein in the selecting of the connection destination, the connection destination is selected, further on the basis of relation information indicating a relation between each of time periods of a day in the home country and a communication data amount of the plurality of session management apparatuses.

17. The mobility management method according to claim 16, wherein
the relation information indicates a relation between each of the time periods of a day in each of the plurality of time zones in the home country and the communication data amount of the plurality of session management apparatuses.

18. The mobility management method according to claim 17, wherein
in a case where the mobility management apparatus cannot establish the communication connection with the connection destination, another connection destination is selected, in the selecting the connection destination, from among the session management apparatuses each belonging to a time zone different from a time zone that the connection destination belongs.

19. The mobility management method according to claim 15, wherein
the mobility management apparatus is a mobility management entity (MME);
the network information management apparatus is a domain name system (DNS); and
the session management apparatus is a packet data network gateway (PGW).

20. The mobility management method according to claim 15, wherein:
the mobility management apparatus is an access and mobility management function (AMF) apparatus;
the network information management apparatus is a network repository function (NRF) apparatus; and
the session management apparatus is a session management function (SMF) apparatus.
